(19) United States
(12) Patent Application Publication
(10) Pub. No.: US 2009/0052971 A1
(43) Pub. Date: Feb. 26, 2009

(54) DELIVERY SYSTEM

(75) Inventors: Leo Clifford Pires, Basking Ridge, NJ (US); Roger Hwang, Maple (CA); Rahul Bose, New Delhi (IN); Koushik Kohli, Ghaziabad (IN); Santosh Mohapatra, Cuttack (IN)

Correspondence Address: PATTERSON & SHERIDAN L.L.P. NJ Office, 595 SHREWSBURY AVE, STE 100, FIRST FLOOR, SHREWSBURY, NJ, 07702, US

(73) Assignee: Zen Design Solutions Limited, Wanchai (HK)

(21) Appl. No.: 11/844,949

(22) Filed: Aug. 24, 2007

(51) Int. Cl. B43K 5/06; B67D 5/52; G01F 11/00

(52) U.S. Cl. 401/172; 222/137; 222/390

(57) ABSTRACT

The present invention generally is a delivery system for simultaneously dispensing two products in metered quantities and in a predetermined ratio. In one embodiment the delivery system includes a barrel, said barrel accommodating a cartridge that forms the first chamber and the resulting free space forms the second chamber; a means for actuating the movement of the components; and an applicator head for applying the dispensed products. The two chambers in the delivery system are arranged in series so as to be in axial alignment with each other. The delivery system according to the present invention could be used for dispensing of cosmetic, skin care, hair care, oral care, personal care, pharmaceutical, wound care, orally administrable products, home-care or adhesives.

### BACKGROUND

1. Field of the Invention

The present invention relates to a delivery system. More particularly it relates to a delivery system that dispenses two products simultaneously in metered amounts and in a predefined ratio. The delivery system of the present invention is designed in such a form that it dispenses even small quantities of the products in precise amounts.

2. Description of the Related Art

Various types of delivery systems have been developed for dispensing a plurality of fluid materials and many a dual containers or multiple product packages are known in the art. A known means for dispensing two products simultaneously involves the use of dual chambers placed adjacently/parallely in a container or a dispensing tube.

U.S. Pat. No. 6,464,107 to Brugger, discloses a proportioning dispenser for proportioning two product components in an adjustable ratio. The product components are supplied from associated accommodating compartments each via a pump unit wherein the adjustment of the mixing ratio is effected by a transmission member, the point of application of which is adjustable with respect to two pump units. The product components are supplied to a common mixing chamber from where a product mixture is conveyed to the dispenser nozzle.

U.S. Pat. No. 5,865,345 to Cistone et al. discloses a tube for dispensing two products simultaneously, and more specifically to a tube having two chambers formed from different materials. The body portion of the tube comprises of two adjacent chambers sharing a common wall wherein each chamber is in fluid communication with an orifice in the neck portion, and wherein the two chambers are formed from different materials.

A finger-actuated dispenser for a multi-component reactant toothpaste is disclosed in the International Application No. PCT/US93/01651 to The Procter & Gamble Company. The dispenser comprises of two co-axial cylinders wherein one of the reservoirs is placed concentrically inside the outer one and each of them is equipped with a knife and piston assembly.

U.S. Pat. No. 5,954,213 to Gerhart et al., discloses a dual bottle formed by two separable interlocked chambers. Each of the chambers contain different ingredients and have adjacent product exit apertures so that after leaving the chambers the separate product streams can mix. U.S. Pat. No. 5,386,928 to Blette discloses a system for dispensing materials made of two components including a side by side pair of collapsible tubes that fit within a barrel of a pressurized air applicator. A dispenser for co-dispensing two products is also disclosed in the International Application No. PCT/IE2005/000026 to Loctite Limited wherein the dispenser comprises of an outer can in which are adjacently placed the two inner containers of collapsible bag type.

Various dual fluid cartridge assemblies are also known. Such dual fluid cartridges assemblies are known to be used to dispense fluid materials such as adhesives, which typically contain two components that need to remain separated and applied quickly after mixing. Examples of such dual fluid cartridges are disclosed in U.S. Pat. Nos. 4,014,463; 4,050,612 and 4,029,036. U.S. Pat. No. 4,050,612 discloses a dispenser containing two different materials such as creams, wherein an upper chamber is telescopically slidably mounted and moved into a lower chamber for simultaneously discharging products from each of the containers at a pair of adjacent openings.

Attempts have also been made to provide a package that facilitates dispensing of two separate products for example in U.S. Pat. No. 5,647,481 to Hundertmark et al., is disclosed a dual container system for two-component hair dye. It discloses that the user assembles the two separate containers at the time of use. The system is such that the second component from the second container is made to enter the first container, thereby permitting mixing of first component with the second component and the mix is dispensed out of the dispensing nozzle.

Although many of these prior art dual product dispensers are relevant with respect to the present invention, most of these dispensers dispense the products after they are mixed in the dispensing or the mixer nozzle. Therefore, the user is unable to know the actual amounts mixed. Further, most of the existing dual dispensers have two chambers that are placed parallel to each other and are also difficult to operate for small and precise quantities of products. Moreover, these dispensers are generally used when large amounts of products are required to be dispensed and therefore require either a pump or a forceful push to dispense the products. Another shortcoming of these existing dispensers is that they are not able to dispense small quantities of products with precision.

Therefore, there is a need in the art for a delivery system or a dispenser that dispenses the products such that upon operation of the dispenser, the two products are dispensed by a minimal force in the desired relationship without requiring any skill on the part of the dispenser operator. It is also desirable that the two products are dispensed in a preset accurately controlled relationship as the user will normally be unskilled in the dispensing art and will not be concerned with or about, nor experienced to identify the correct quantity and the ratio of the two components in forming the final product.

### SUMMARY

The present invention generally is a delivery system for dispensing simultaneously two products in metered amounts in a predetermined ratio and with precision. The delivery system is also referred to as a dispenser in the specification.

According to an embodiment of the invention, there is provided a dispenser in which a minimal force when applied through the actuator will synchronously dispense the two products from their respective chambers in controlled and desired amounts.

In accordance with another embodiment of the invention, the dual product delivery system of the invention comprises a hollow barrel which is comprising of a first chamber and a second chamber containing the first and the second products respectively, a means for actuating and an applicator head for applying the first and second products in a mixed state,

According to another embodiment of the invention, the chambers are arranged in a series in a hollow barrel and are axially aligned to each other. The barrel could have any shape such as cylindrical, rectangular or any other suitable shape. Each of said chambers houses a piston assembly for discharging a first and a second product respectively, wherein the piston assembly of first chamber comprises of a piston, a piston ring and a hollow delivery screw and the piston assembly of second chamber comprises a piston, a piston ring and a delivery tube. The linear force provided by the actuator effects synchronous displacement of both pistons with respect to their respective chambers for discharging the products therefrom.

According to another embodiment of the invention, both the pistons are attached to a hollow delivery screw, wherein the movement of the actuator causes advancement of the hollow delivery screw. The advancement of the delivery screw in turn causes simultaneous axial displacement of both the pistons. With the displacement of the pistons, the first product in the first chamber is pushed into the hollow delivery screw through the orifices provided in the delivery screw traveling further into the delivery tube and into the applicator head. While the second product in the second chamber moves into the delivery tube array and then into the applicator head through the aligned openings present in both the array and the applicator. The first product in the first chamber is carried towards the applicator via the delivery tube which telescopes into the hollow delivery screw.

According to another embodiment of the invention there is provided a dispenser which is attractive, easy to carry in bags etc. and easy-to-use by the customer and does not require the customer to work on the amounts or the ratios that he/she wishes to use.

According to yet another embodiment of the invention is also provided a versatile delivery system that can be used to dispense a wide variety of consumer and industrial products related to cosmetic, skin care, hair care, oral care, personal care, pharmaceutical, wound care, orally administrable products, home-care or adhesives.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings.

FIG. 1 is an isometric view of the delivery system according to one embodiment of the present invention.

FIG. 2 is an exploded view of the delivery system as shown in FIG. 1.

FIG. 3 is a cross-sectional view, in the plane A-A′ of the delivery system shown in FIG. 1 showing the delivery system in a fully-filled condition.

FIG. 4 is a cross-sectional view, in the plane A-A′ of the delivery system shown in FIG. 1 showing the delivery system in a half-filled condition

FIG. 5 is a cross-sectional view, in the plane A-A′ of the delivery system shown in FIG. 1 showing the delivery system in an empty/fully dispensed condition.

To facilitate understanding, identical reference numerals have been used, where possible, to designate identical elements that are common to the figures. It is to be noted, however, that the appended drawings illustrate only typical embodiments of this invention and are therefore not to be considered limiting of its scope, for the invention may admit to other equally effective embodiments.

### DETAILED DESCRIPTION

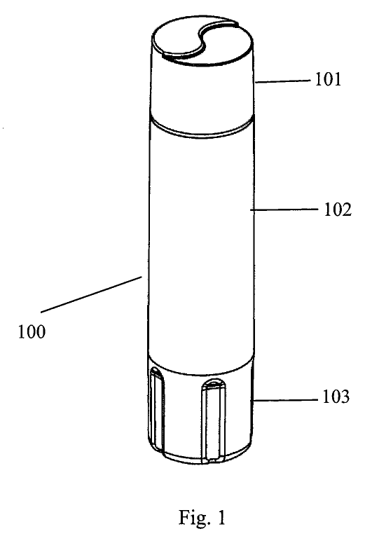

The delivery system according to one embodiment of the present invention is shown in FIG. 1. As used herein, the term “dispenser” should be regarded as synonymous with “delivery system” unless otherwise specified.

The dispenser 100 consists of a cap 101, body 102 and an actuator 103. The cap 101 may be formed from a polymeric material such as polypropylene, acrylonitrile butadiene styrene or styrene acrylonitrile. The body 102 of the dispenser is comprised of a hollow cylindrical barrel 104 which may be formed of a polymeric material such as propylene. The barrel could have any shape such as cylindrical, rectangular or any other suitable shape. The actuator 103 may be formed of styrene acrylonitrile or acrylonitrile butadiene styrene. The actuator 103 provides the force to actuate the movement of the two products. However, the force required to operate the dispenser, may be applied manually, pneumatically, hydraulically or through various other types of displacement mechanisms.

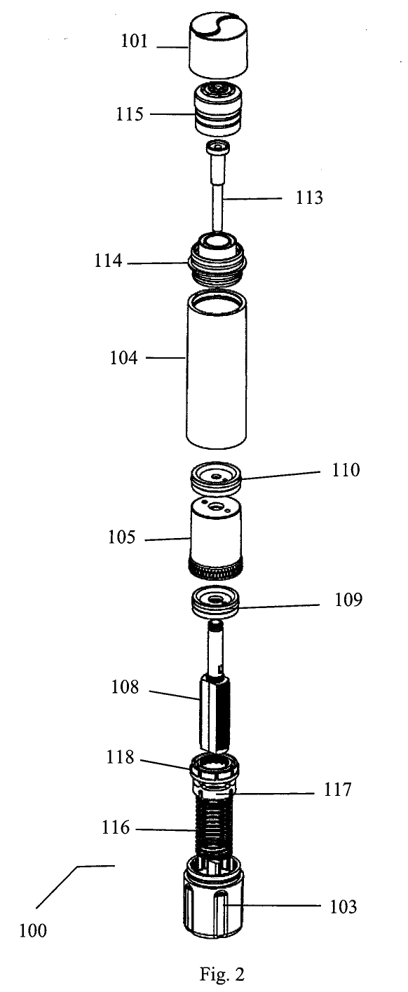

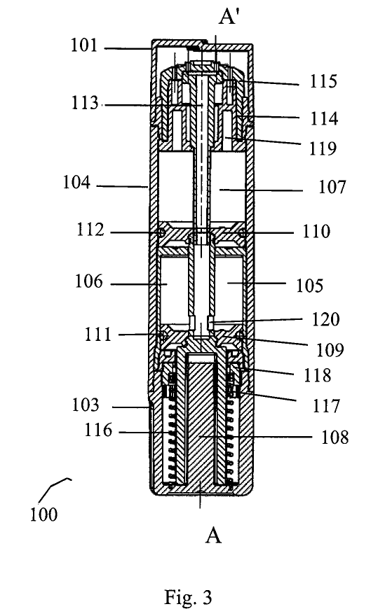

Referring to the FIGS. 2 and 3, the dispenser 100 as shown in FIG. 2 comprises of barrel 104 which comprises of a first chamber 106 and a second chamber 107 that are arranged in series and are in axial alignment with each other. The delivery system also comprises a delivery tube array that is connected to an applicator 115. The first chamber 106 is formed of a cartridge 105 which is placed inside the barrel 104, while the resulting free space in the barrel forms the second chamber 107. The first chamber 106 and the second chamber 107 contain the first and the second product respectively. The first piston 109 is positioned at the rear end of cartridge 105 and is snap-fitted onto the hollow delivery screw 108 while a piston ring 111 is fitted in the piston 109 to seal the cartridge, thereby providing an air-tight first chamber for containing the first product. The second piston 110 is placed in the barrel 104 at the top of the cartridge 105 and piston ring 112 is fitted onto the piston thereby forming an air-tight second chamber for containing the second product. The second piston 110 is connected to the delivery screw 108 by a snap-fit mechanism. The rear end of the barrel 104 mates with the cog 118 and the actuator 103 while the top of the barrel 104 snaps into the delivery tube array 114. The delivery screw 108 is connected to the rear end of the actuator 103 through the cog 118, the ratchet 117 and a spring 116. The spring 116 is placed in the actuator 103. The delivery screw 108 sits inside the actuator 103. The inside wall of the actuator 103 has ribs that are complementary to the protrusions in the ratchet 117 and this keeps the ratchet 117 fixed onto the spring 116. The cog 118 is fixed on the ratchet 117 with the help of complementing threads in both the parts and this assembly of cog 118 and ratchet 117 is positioned in the middle of the delivery screw 108. The ridges on upper surface of the ratchet 117 mate with the ridges on the cog 118 to enable propel or repel motion with a tactile feel and the protrusions in the outside of the ratchet 117 mate with the actuator's inside and prevent the ratchet 117 from turning. The spring 116 ensures that the ratchet is kept up against the cog 118 thereby providing a good tactile user interface when the actuator 103 is turned. The delivery screw 108 extends through the cartridge 105 and terminates at the lower end of a delivery tube 113. The delivery tube 113 is so arranged that it telescopically slides in the delivery screw 108. The delivery tube 113 extends through the second chamber 107 and fits onto the applicator 115. The applicator 115 has orifices in it that are aligned with the opening of the delivery tube 113, thereby allowing the first product to travel up to the applicator 115.

As the actuator 103 is turned the delivery screw 108 rises upwards. The advancement of the delivery screw 108 caused by turning of the actuator 103 results in simultaneous axial displacement of both the pistons. With the displacement of the pistons, first product is pushed into the hollow delivery screw 108 through the orifices 120 present in the delivery screw 108 while second product enters the applicator 115 through the openings 119 in the delivery tube array 114 that are in alignment with the holes in the applicator 115. The first product is carried further up towards the applicator 115 via the delivery tube 113 which telescopes into the delivery screw 108.

FIG. 3 shows dispenser 100 in a fully filled condition with both first chamber 106 and the second chamber 107 being filled with the first and second products, respectively. In filled condition, the first piston 109 and first piston ring 111 will be positioned adjacent to the top end of the cog 118 and the second piston 110 and second piston ring 112 will be in an abutting relationship with the upper surface of the cartridge 105. The delivery screw 108 in the filled condition will also be filled. As the actuator 103 is turned, the first piston 109 is displaced up forcing the first product along with it. As the first product comes near to the orifice 120 in the delivery screw 108, a metered amount of the first product enters the delivery screw 108 and it forces the first product into the applicator 115 via the delivery tube 113.

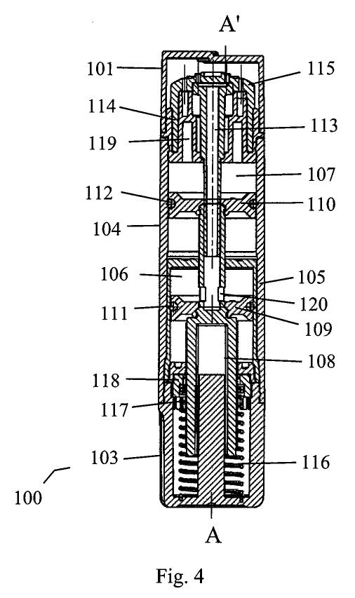

Upon the advancement of the first piston 109 and first piston ring 111 the delivery screw 108 moves up and telescopically slides onto the delivery tube 113, which results in the propelling of the second piston 110 and piston ring 112. Upward displacement of second piston 110 in turn will force the second product out of the second chamber 107 into the applicator 115 via the openings 119 in the delivery tube array 114. This is shown in the FIG. 4 where both the chambers are half filled as both the products have been dispensed. Thus, the concurrent displacement of pistons 109 and 110 will result in the simultaneous dispensing of both the products from their respective chambers in a predetermined relationship assuming that both chambers are filled as shown in FIG. 2 at the start of the dispensing operation.

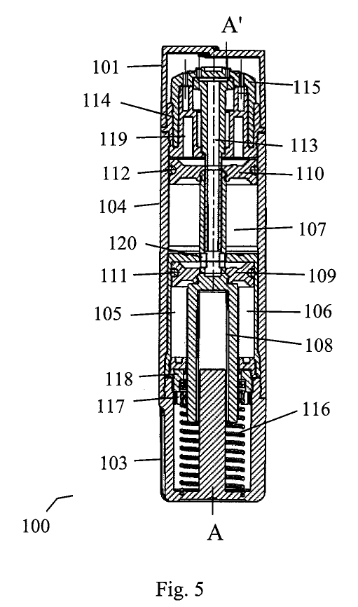

FIG. 5 shows the position of the various dispenser components at the end of the complete dispensing of the contents, at which position, the first piston 109 and first piston ring 111 will be adjacently placed below the upper surface of the cartridge 105 and the second piston 110 and second piston ring 112 will be in an abutting relationship with the lower surface of the delivery tube array 114. The delivery screw 108 will be positioned on the upper rings of the spring 116 as it would have moved the total distance to finish the products.

It is well understood by a person skilled in the art that the dispenser can also be arranged in a manner that both pistons can also be retracted by the user with the help of actuator itself. This feature is helpful in sucking back any excess part of the product that had been dispensed.

The materials suitable for forming the delivery screw 108 and delivery tube 113 could be polyacetal while the cog 118 and ratchet 117 could be formed of either nylon or polyacetal. The material of spring 116 could be made of metal for example steel. The cartridge 105 and the delivery tube array 114 may be formed of polypropylene. The material for forming pistons could be selected from polypropylene, polyacetal or low-density polyethylene while the piston rings could be formed of an elastomer. The applicator may be made from acrylonitrile butadiene styrene, injection molded surlyn or injection molded silicone. The applicator could also be made of a combination of both injection molded surlyn and injection molded silicone. The aforementioned materials for forming various parts of the dispenser of the present invention are an example, however other suitable materials may also be used.

The dispenser 100 of the present invention can also be arranged to dispense materials in the chambers in any predetermined ratio for example 50:50, 60:40, 70:30 etc. by varying the internal diameter of the cartridge and/or barrel. Similarly, the amount of the products dispensed from the two chambers can be varied by miniaturizing the dispenser or by varying the internal diameter of the cartridge and/or barrel. The dispenser can also be arranged to dispense two materials of differing viscosities simultaneously by varying the orifice diameter of the opening. It is well understood by a person skilled in the art that by changing the pitch of the screw, the amount of the products dispensed per user turn can also be varied. Accordingly, a significant advantage of the embodiments of the present invention is that the predefined dispensing amounts of both the products can be precisely dispensed. The delivery system 100 of the present invention can precisely dispense at least 1 microlitre of each of the products simultaneously. However, as may be recognized by those of ordinary skill in the pertinent art based on the teachings herein, the amounts to be dispensed may be set to any amounts that may be required for a particular application.

Although the above description and drawings show the dispenser, and in particular the chambers thereof, being cylindrical, the shapes and profile cross section thereof are not limited to the same. Also, the applicator 115 of the present invention could be cylindrical and slightly domed on top having concentric grooves with multiple orifices that contain the products when they are being dispensed. The applicator top could alternatively have concentric fins instead of grooves which help in mixing of the products during application. However, the applicator could have any suitable form to target a specific application.

The delivery system of the present invention could be put to use for such consumer products where it is desirable to keep one or more of the components separate until just before dispensing them in the final product. It could be used in the cosmetic products that require a mixture of such ingredients that undesirably tend to break down if the components are allowed to co-exist together for an extended period of time. For example surfactant and conditioner ingredients in shampoos, surfactants and moisturizer ingredients in shower gels the vitamins in cosmetic preparations or the components of a hair dye could be stored and dispensed separately. The delivery system of present invention can also provide for variation of similar products for example different shades or flavors of lip-balm. The delivery system of the present invention could allow for use of many combinations of complementary products in certain pharmaceutical preparations.

Various examples of the products where the delivery system of the present invention could be used are but not limited to cheek blush and vitamins, cheek blush and cheek plumping gel/cream, lip plumping gel/cream and moisturizer, two different temporary hair colors, hair styling gel and glitter, hair styling gel and colour, hair mousse and hair repair cream, exfoliant and hydrating cream, antiseptic and correction cream, acne treatment cream and concealer, blemish concealer and skin treatment cream, hair repair cream and anti-dandruff cream, hair treatment serum and scalp hydrating oils, teeth whitening gel and mouth wash, teeth whitening and teeth lamination solutions, pain relieving cream and cooling serum, antibiotic cream and analgesic cream, two active antibiotic creams, antipyretic and analgesic serums/solutions, bleaching agent and fabric softener, stain remover and sanitizer, bleaching agent and fragrant solution while in adhesives the two active adhesive gels could be dispensed by the delivery system of the present invention.

Another advantage provided is the provision of a transparent outer body area that would keep the user informed of the products kept inside the dispenser and thereby making it informative as well as attractive for the user.

Thus, dispenser 100 provides a dual product delivery system, which is simplified, provides an effective, inexpensive, and efficient device that achieves all the enumerated objectives and obtains new results in the art.

While the foregoing is directed to embodiments of the present invention, other and further embodiments of the invention may be devised without departing from the basic scope thereof, and the scope thereof is determined by the claims that follow. Accordingly, the appended claims should be construed to encompass not only those forms and embodiments of the invention specifically described above, but to such other forms and embodiments as may be devised by those skilled in the art without departing from its true spirit and scope.

What is claimed is:

1. A delivery system for simultaneously dispensing two products in a predetermined ratio comprising:
a barrel, said barrel comprising a first chamber and a second chamber containing the first and the second product respectively;
wherein the first chamber is formed by a cartridge that is accommodated inside the barrel and the resulting free space forms the second chamber
wherein each of the said chambers houses a piston assembly;
a means for actuating the movement of said pistons; and
an applicator head for applying the first and second products in a mixed state,
said delivery system characterised in that the two chambers are arranged in series so as to be in axial alignment with each other.

2. The delivery system according to claim 1 further comprising a delivery tube array which is connected to the applicator head.

3. The delivery system according to claim 1 wherein said piston assembly of first chamber comprises of a piston, a piston ring and a hollow delivery screw and the said piston assembly of second chamber comprises a piston, a piston ring and a delivery tube.

4. The delivery system according to claim 3 wherein each of the piston is connected to the hollow delivery screw.

5. The delivery system according to claim 3 wherein the hollow delivery screw and the delivery tube are positioned in the first and the second chamber respectively.

6. The delivery system according to claim 5 wherein the delivery tube is arranged so as to be telescopically slidable into the hollow delivery screw.

7. The delivery system according to claim 3 wherein the advancement of the hollow delivery screw is caused by the movement of the actuator.

8. The delivery system according to claim 7 wherein advancement of the hollow delivery screw causes simultaneous axial displacement of the pistons to force the first and the second products to be dispensed from the said chambers respectively.

9. The delivery system according to claim 5 wherein the product in the first chamber travels through the hollow delivery screw towards the applicator via the delivery tube.

10. The delivery system according to claim 8, wherein in the hollow delivery screw are provided orifices through which the product in the first chamber is pushed towards the applicator.

11. The delivery system according to claim 8 wherein the second product enters the applicator through the openings in the delivery tube array that are in alignment with the holes in the applicator.

12. The delivery system according to claim 1 wherein a single turn of the actuator synchronously dispenses the two dispensable products from their respective chambers in metered amounts.

13. The delivery system according to claim 1 wherein the delivery system dispenses at least 1 microlitre of each of the products simultaneously.

14. The delivery system according to claim 1 wherein the barrel and cartridge are transparent.

15. The delivery system according to claim 1 wherein the delivery system dispenses the two products in precise amounts.

16. The delivery system according to claim 1 wherein first and second products are required to be mixed during application and comprise at least one of cosmetic, skin care, hair care, oral care, personal care, pharmaceutical, wound care, orally administrable products, home-care or adhesives.

17. A delivery system for simultaneously dispensing two products in a predetermined ratio comprising:
a barrel, said barrel comprising a first chamber and a second chamber containing the first and the second product respectively; wherein the first chamber is formed by a cartridge that is accommodated inside the barrel and the resulting free space forms the second chamber, and wherein the two product holding chambers are arranged in series so as to be in axial alignment with each other;
a first piston assembly disposed in the first product holding chamber, the first piston assembly comprising a piston, a piston ring and a hollow delivery screw;
a second piston assembly disposed in the second product holding chamber, the second piston assembly comprising a piston, a piston ring and a delivery tube, wherein the delivery tube is arranged so as to be telescopically slidable into the hollow delivery screw, wherein the first and second pistons are connected to the hollow delivery screw, and wherein the hollow delivery screw is advancable in the barrel;
a means for actuating the movement of said pistons and
an applicator coupled to barrel through a delivery tube array wherein the applicator is configured to channel products displaced from the product holding chambers by advancement of the pistons to an applicator outlet
